(19) United States
(12) Patent Application Publication
(10) Pub. No.: US 2026/0036437 A1
(43) Pub. Date: Feb. 5, 2026

(54) TRAVELING STATE PREDICTION DEVICE AND METHOD

(71) Applicant: DENSO CORPORATION, Kariya-City (JP)

(72) Inventors: Yuki KISHITA, Kariya-City (JP); Hiroyuki NANJO, Kariya-City (JP)

(21) Appl. No.: 19/281,953

(22) Filed: Jul. 28, 2025

(30) Foreign Application Priority Data
Jul. 30, 2024 (JP) 2024-123448

(51) Int. Cl. G01C 21/36

(52) U.S. Cl. CPC G01C 21/3691

(57) ABSTRACT

A traveling state prediction device for predicting a traveling state of a host vehicle, includes an index acquisition unit that acquires a traffic condition index which is an index of a traffic condition on a planned travel route of the host vehicle, a variation factor acquisition unit that acquires a traffic variation factor which is a factor that causes variations in the traffic condition, and a deceleration location prediction unit that predicts a deceleration location of the host vehicle on the planned travel route based on the traffic variation factor and the traffic condition index. The deceleration location prediction unit predicts the deceleration location based on a relationship between the traffic condition indices in two different situations for a certain traffic variation factor, or a relationship between the traffic condition index corresponding to a certain traffic variation factor and the traffic condition index under an average traffic condition.

### CROSS-REFERENCE TO RELATED APPLICATION

This application is based on and claims the benefit of priority from earlier Japanese Patent Application No. 2024-123448 filed Jul. 30, 2024, the description of which is incorporated herein by reference.

### BACKGROUND

### Technical Field

The present disclosure relates to a traveling state prediction device and a traveling state prediction method.

### Related Art

A technique is known that estimates energy consumption by a vehicle drive source, taking into account driving behaviors of the vehicle when traveling through an intersection. Specifically, such a technique predicts the behavior of the vehicle, that is, whether it will go straight, turn right, or turn left, at each intersection included in a planned travel route of a host vehicle. The known technique also acquires attribute information of intersections and roads connected to the intersections. The attribute information includes the presence or absence of traffic signals, the presence or absence of pedestrian crossings, the number of lanes, and speed limits. Then, the vehicle energy consumption estimation device calculates a stop probability based on the acquired information and an energy consumption estimation table, and estimates the energy consumed by a drive motor based on acceleration resistance using the calculated stop probability.

### BRIEF DESCRIPTION OF THE DRAWINGS

In the accompanying drawings:

FIG. 1 is a schematic block diagram of a traveling state prediction device according to one embodiment of the present disclosure;

FIG. 2 is a graph to schematically illustrate operations of the traveling state prediction device according to a first embodiment illustrated in FIG. 1;

FIG. 3 is a graph to schematically illustrate operations of the traveling state prediction device according to the first embodiment illustrated in FIG. 1;

FIG. 4 is a graph to schematically illustrate operations of the traveling state prediction device according to the first embodiment illustrated in FIG. 1;

FIG. 5 is a flowchart schematically illustrating operations of the traveling state prediction device according to the first embodiment illustrated in FIG. 1;

FIG. 6 is a graph to schematically illustrate operations of the traveling state prediction device according to a second embodiment illustrated in FIG. 1; and

FIG. 7 is a graph to schematically illustrate operations of the traveling state prediction device according to the second embodiment illustrated in FIG. 1.

### DESCRIPTION OF SPECIFIC EMBODIMENTS

As described above, the known technique, as disclosed in JP 2009-67350 A, estimates energy consumption based on the stop probability. However, the stop probability varies depending on traffic conditions, even for the same route and location, since traffic congestion increases the likelihood of stopping at traffic signals. Thus, according to the technique described in JP 2009-67350 A, errors may occur in the estimated energy consumption due to changes in traffic conditions.

In view of the foregoing, it is desired to have a technique for improving the prediction accuracy in predicting a traveling state of a host vehicle as compared with conventional techniques.

A first aspect of the present disclosure provides a traveling state prediction device for predicting a traveling state of a host vehicle. The traveling state prediction device includes: an index acquisition unit configured to acquire a traffic condition index which is an index of a traffic condition on a planned travel route of the host vehicle; a variation factor acquisition unit configured to acquire a traffic variation factor which is a factor that causes variations in the traffic condition; and a deceleration location prediction unit configured to predict a deceleration location of the host vehicle on the planned travel route based on the traffic variation factor and the traffic condition index. The deceleration location prediction unit is configured to predict the deceleration location based on a relationship between the traffic condition indices in two different situations for a certain traffic variation factor, or a relationship between the traffic condition index corresponding to a certain traffic variation factor and the traffic condition index under an average traffic condition.

A second aspect of the present disclosure provides a traveling state prediction method for predicting a traveling state of a host vehicle. The traveling state prediction method includes: acquiring a traffic condition index which is an index of a traffic condition on a planned travel route of the host vehicle; acquiring a traffic variation factor which is a factor that causes variations in the traffic condition; and predicting a deceleration location of the host vehicle on the planned travel route based on the traffic variation factor and the traffic condition index. The predicting a deceleration location of the host vehicle includes predicting the deceleration location based on a relationship between the traffic condition indices in two different situations for a certain traffic variation factor, or a relationship between the traffic condition index corresponding to a certain traffic variation factor and the traffic condition index under an average traffic condition.

A third aspect of the present disclosure provides a program product including: a non-transitory computer-readable medium; and instructions stored on the non-transitory computer-readable medium that, when executed by a processor, cause the processor to perform a process for predicting a traveling state of a host vehicle. The process includes operations of: acquiring a traffic condition index which is an index of a traffic condition on a planned travel route of the host vehicle; acquiring a traffic variation factor which is a factor that causes variations in the traffic condition; and predicting a deceleration location of the host vehicle on the planned travel route based on the traffic variation factor and the traffic condition index. The operation of predicting a deceleration location of the host vehicle includes predicting the deceleration location based on a relationship between the traffic condition indices in two different situations for a certain traffic variation factor, or a relationship between the traffic condition index corresponding to a certain traffic variation factor and the traffic condition index under an average traffic condition.

A fourth aspect of the present disclosure provides a non-transitory computer-readable medium storing instructions that, when executed by a processor, cause the processor to perform a process for predicting a traveling state of a host vehicle. The process includes operations of: acquiring a traffic condition index which is an index of a traffic condition on a planned travel route of the host vehicle; acquiring a traffic variation factor which is a factor that causes variations in the traffic condition; and predicting a deceleration location of the host vehicle on the planned travel route based on the traffic variation factor and the traffic condition index. The operation of predicting a deceleration location of the host vehicle comprises predicting the deceleration location based on a relationship between the traffic condition indices in two different situations for a certain traffic variation factor, or a relationship between the traffic condition index corresponding to a certain traffic variation factor and the traffic condition index under an average traffic condition.

### Embodiments

Hereinafter, exemplary embodiments and specific examples of the present disclosure will be described with reference to the accompanying drawings as appropriate. It should be noted that the following embodiments, their modifications, and the accompanying drawings are schematically or simplistically presented for the purpose of concisely explaining the content of the present disclosure, and therefore do not limit the scope of the present disclosure in any way. Accordingly, it goes without saying that the configurations illustrated in the drawings do not necessarily coincide with the specific device configurations that may actually be manufactured and marketed. That is, unless the applicant explicitly limits the scope of the present application during prosecution, the present disclosure should not be construed in a limited manner based on the illustrations in the drawings and the descriptions of the corresponding device configurations, functions, or operations set forth below.

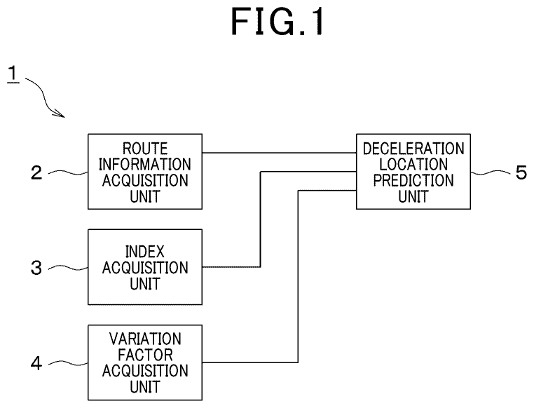

Referring to FIG. 1, a traveling state prediction device 1 according to the present embodiment is configured to predict a traveling state of a vehicle. A vehicle whose traveling state is to be predicted by the traveling state prediction device 1 is hereinafter referred to as a “host vehicle.” Typically, the host vehicle is a vehicle to which the traveling state prediction device 1 is mounted.

In the present embodiment, the traveling state prediction device 1 is configured as an on-board microcomputer mounted to the host vehicle, that is, as an ECU. The “ECU” is an abbreviation for Electronic Control Unit. That is, the traveling state prediction device 1 includes a processor configured as a CPU or an MPU, and a storage medium communicatively connected to the processor, and is configured to implement predefined functions by loading and executing a computer program stored in the storage medium. Hereinafter, the processor and the storage medium provided in the traveling state prediction device 1 will be simply referred to as a “processor” and a “storage medium,” respectively.

The storage medium includes at least a ROM or a non-volatile rewritable memory, among various non-transitory tangible storage media such as the ROM and non-volatile rewritable memory. The non-volatile rewritable memory is a storage device capable of being rewritten during power on and of retaining information in a non-rewritable state during power off, such as flash memory. The storage medium stores, along with the computer program described above, data necessary for executing the computer program, such as initial values, maps, and lookup tables. The storage medium is configured to store various items of information, such as image data and drive data acquired while the host vehicle is traveling, in a predefined capacity.

As illustrated in FIG. 1, the traveling state prediction device 1 includes, as functional blocks implemented by an on-board microcomputer executing the computer program, a route information acquisition unit 2, an index acquisition unit 3, a variation factor acquisition unit 4, and a deceleration location prediction unit 5. These functional blocks will now be described in order.

The route information acquisition unit 2 is configured to acquire information on a planned travel route of the host vehicle from a navigation device mounted to the host vehicle or from an external server. The information on the planned travel route includes, for example, a destination, waypoints, intersections scheduled to be passed from the current location to the waypoints or the destination, intended directions of travel at such intersections, road widths, the number of lanes, legal speed limits, and the like.

The index acquisition unit 3 is configured to acquire a traffic condition index, which is an index relating to traffic conditions on the planned travel route of the host vehicle acquired by the route information acquisition unit 2. Specifically, the index acquisition unit 3 is configured to acquire (i.e., read and retain for a predefined period) information corresponding to the traffic condition index from, for example, a predefined storage area of the above-described storage medium or from an external server. Here, the “traffic condition” refers to a condition of traffic of vehicles on a road. The “condition of traffic” may include, for example, whether the traffic is flowing smoothly or not. Accordingly, the “traffic condition index” includes, for example, vehicle speed, vehicle density, traffic volume, or a rate of change of any of these values over time (i.e., an amount of change per unit time), and the like. The traffic volume may be, for example, the number of vehicles passing a given location within a predefined time or per unit time.

Specifically, the traffic condition index may include, for example, a vehicle speed pattern of an individual vehicle, or an average of vehicle speed patterns of a plurality of vehicles. The vehicle speed pattern of the host vehicle as an individual vehicle, that is, a past vehicle speed pattern during travel of the host vehicle, may be read out from the storage medium, for example. The vehicle speed pattern of a certain other vehicle as an individual vehicle may be acquired via vehicle-to-vehicle communication or from an external server. The average of vehicle speed patterns of a plurality of vehicles may be acquired from an external server. In an alternative, when the planned travel route is divided into a plurality of sections, the traffic condition index may include, for example, a vehicle speed for each section. In another alternative, the traffic condition index may include, for example, traffic volume at a plurality of locations along the planned travel route. It should be noted that the traffic condition or traffic condition index may also be referred to as a “traffic condition quantity.”

The variation factor acquisition unit 4 is configured to acquire a traffic variation factor, which is a factor that causes variations in traffic condition. Specifically, the variation factor acquisition unit 4 may be configured to acquire information corresponding to the traffic variation factor from, for example, an external server.

The “traffic variation factor” includes, for example, information relating to time and/or date. The information relating to time and/or date includes, for example, time slots, days of the week, weekdays/holidays, date ranges, months, seasons, and the like. For example, events such as sports events, entertainment events, traffic regulations, demonstration marches, and construction carried out during certain dates and time slots or date and time ranges may affect traffic conditions. Such traffic-affecting events can be recognized as a combination of time and date information, that is, as information relating to time and/or date. The “traffic variation factor” also includes, for example, traffic volume and weather. It should be noted that congestion information represents a traffic condition, but it may be treated as either a traffic condition index or a traffic variation factor. Here, a distinction may be made between the type of traffic variation factor (e.g., weather, time slots, etc.) and information corresponding to the content or acquisition result of a certain type of traffic variation factor (e.g., whether the traffic variation factor indicates rainy or sunny conditions in the case of weather). In such a case, the former may be referred to as a “factor type,” and the latter may be referred to as “factor information.” The factor information may also be referred to as a “factor information acquisition value,” a “factor acquisition result information,” a “factor value,” or a “factor level.”

The deceleration location prediction unit 5 is configured to predict a deceleration location of the host vehicle on the planned travel route, based on the traffic condition index acquired by the index acquisition unit 3 and the traffic variation factor acquired by the variation factor acquisition unit 4. Specifically, in the present embodiment, the deceleration location prediction unit 5 is configured to predict a deceleration location based on the relationship between traffic condition indices under two different conditions of a specific traffic variation factor (e.g., rainy vs. sunny weather when the specific traffic variation factor is weather), or based on the relationship between a traffic condition index corresponding to a certain traffic variation factor and a traffic condition index under the average traffic condition. That is, the deceleration location prediction unit 5 is configured to predict a deceleration location based on the relationship between traffic condition indices corresponding to different factor information, or based on the relationship between a traffic condition index corresponding to certain factor information and a traffic condition index under the average traffic condition.

In the present embodiment, “deceleration” at the “deceleration location” as used herein includes stopping and substantial stopping. The term “substantial stopping” includes a temporary decrease in speed (e.g., within a few seconds) from a speed during normal travel (e.g., typically over 10 km/h) to a slow speed or lower such as when passing through an intersection where there is no obligation to stop. The slow speed is a speed of 10 km/h at which the vehicle can stop within one meter. The term “slow speed” also includes a “very slow speed” that is a speed of several kilometers per hour. In other words, the “deceleration” at the “deceleration location” as used herein refers to a temporary decrease in speed requiring subsequent acceleration or equivalent acceleration to start moving. Therefore, the “deceleration location” may also be referred to as a “stop location” or a “substantial stop location.” Accordingly, the “deceleration location” in the present embodiment does not include a location where the legal speed limit changes or the start point of a congested section in expressway information.

Hereinafter, an example will be described in which a deceleration location is predicted based on a difference (e.g., a delta or a ratio) between two traffic condition indices associated with a certain traffic variation factor, or based on a difference between a traffic condition index associated with a certain traffic variation factor and a traffic condition index under the average traffic condition. That is, in each of the following examples, a deceleration location is predicted based on a relationship between traffic condition indices corresponding to different factor information, or based on a difference between a traffic condition index corresponding to certain factor information and a traffic condition index under the average traffic condition.

### First Embodiment

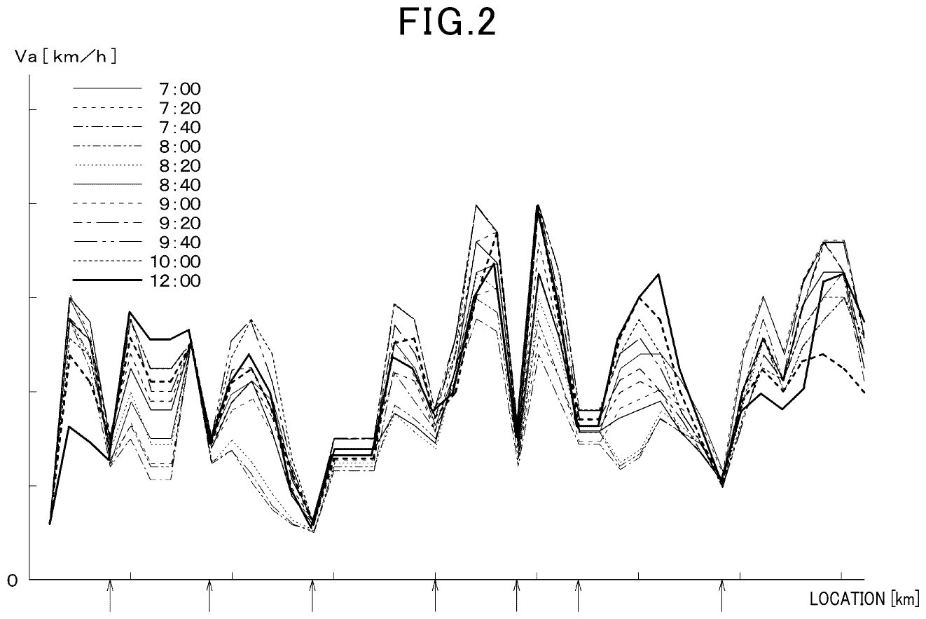

The present embodiment is an example of extracting deceleration locations based on time variations in vehicle speed, using time slots as a traffic variation factor. FIG. 2 illustrates the point-to-point average vehicle speed Va for each time slot along a planned travel route. The point-to-point average vehicle speed Va refers to an average speed for each section when the planned travel route is divided into a plurality of sections (e.g., at 100 m intervals). Specifically, for example, the graph of the point-to-point average vehicle speed Va at “7:00” is a line graph in which the average speed for each section during a 20-minute period centred at 7:00, that is, from 6:50 to 7:10, is plotted using the midpoint of each section as the representative location. The solid arrows shown along the horizontal axis of FIG. 2 indicate deceleration locations that occur regardless of the time slots.

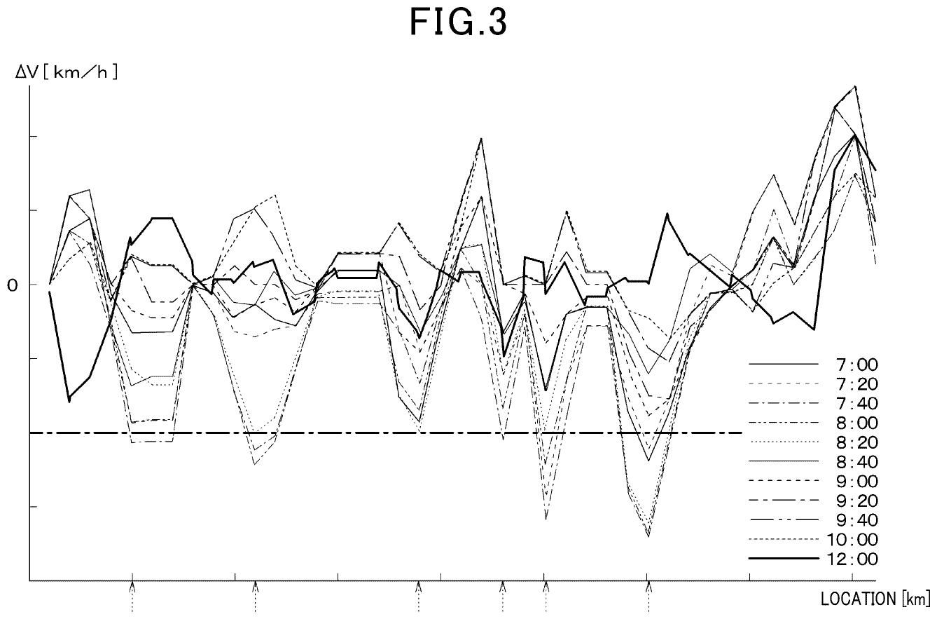

FIG. 3 illustrates differences in the point-to-point average vehicle speed Va between each time slot as shown in FIG. 2 and a specific reference time slot. The differences in the point-to-point average vehicle speed Va are hereinafter denoted by ΔV. As can be seen from FIG. 3, deceleration occurs at locations of local minima of the difference value ΔV. That is, the dashed arrows shown along the horizontal axis of FIG. 3 indicate positions corresponding to local minima that fall below a threshold represented by the dashed-dotted line, and these positions correspond to deceleration locations occurring in certain time slots.

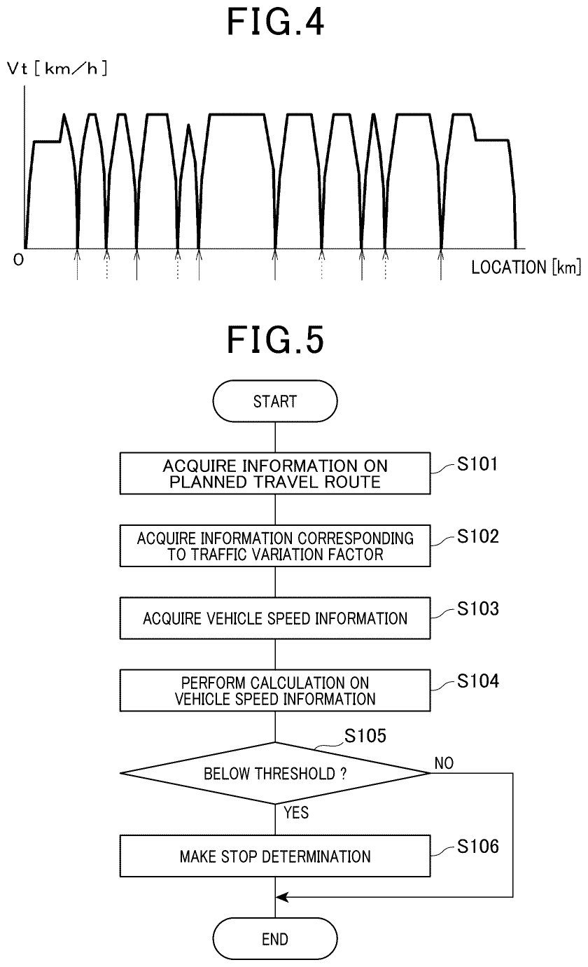

FIG. 4 illustrates a result of predicting the traveling state of the host vehicle, that is, a result of determining the predicted vehicle speed Vt of the host vehicle, which is acquired by combining the deceleration locations that are independent of the time slots, as illustrated in FIG. 2, with the deceleration locations that are dependent on the time slots, as illustrated in FIG. 3. FIG. 5 illustrates an example of a deceleration location estimation process according to the present embodiment, for acquiring such a predicted vehicle speed Vt. In the flowchart illustrated in FIG. 5, the letter “S” is an abbreviation for “Step.”

Upon initiation of the deceleration location estimation process illustrated in FIG. 5, the processor first performs the processing at steps 101 to 103. After completion of the processing at step 103, the processor proceeds to step 104 and the subsequent steps. The processing at step 104 and the subsequent steps corresponds to the operation of the deceleration location prediction unit 5.

At step 101, the processor acquires information on the planned travel route of the host vehicle. The processing at step 101 corresponds to the operation of the route information acquisition unit 2. At step 102, the processor acquires information corresponding to a traffic variation factor. The processing at step 102 corresponds to the operation of the variation factor acquisition unit 4.

At step 103, the processor acquires vehicle speed information. More specifically, the processor acquires two types of vehicle speed information associated with a certain traffic variation factor, and in the present embodiment, for example, acquires a vehicle speed pattern in a predefined reference time slot and a vehicle speed pattern in a current time slot that includes the present time. The processing at step 103 corresponds to the operation of the index acquisition unit 3.

At step 104, the processor performs a calculation on the vehicle speed information acquired at step 103. Specifically, in the present embodiment, the processor calculates the difference between the two types of acquired vehicle speed information. At step 105, the processor performs a stop determination based on the calculation result from step 104 and a threshold value. Specifically, in the present embodiment, as illustrated in FIG. 3, the processor determines whether a local minimum of the difference value ΔV falls below the threshold (i.e., whether it falls below the threshold in FIG. 3).

The processor sets a deceleration location by performing the processing at step 106 according to the result of determination at step 105. Specifically, at step 106, the processor sets a position where a local minimum of the difference value ΔV falls below the threshold as a deceleration location. On the other hand, the processor does not set a position where a local minimum of the difference value ΔV does not fall below the threshold as a deceleration location.

As described above, in the present embodiment, calculating the difference based on the vehicle speed corresponding to a reference traffic condition allows deceleration locations to be estimated with high accuracy. That is, for example, by using differences in vehicle speed and traffic volume under different driving conditions (e.g., commuting time slots and normal time slots) and different traveling states (e.g., traffic congestion and normal traffic), it is possible to estimate deceleration locations that accurately reflect traffic information. Therefore, according to the present embodiment, it is possible to improve the prediction accuracy in predicting the traveling state of the host vehicle as compared with conventional techniques. It should be noted that the reference value used for calculating the difference value ΔV may be a value in a specific time slot, as in the above example, or may be an average value over all time slots.

### Second Embodiment

A second embodiment of the present disclosure will now be described. In the following description of the second embodiment, differences from the first embodiment will primarily be described. Components that are identical or equivalent between the first and second embodiments are assigned the same reference numerals. Accordingly, in the following description of the second embodiment, the explanations provided in the first embodiment may be appropriately applied to components having the same reference numerals as in the first embodiment, unless there is any technical inconsistency or need for special additional explanation.

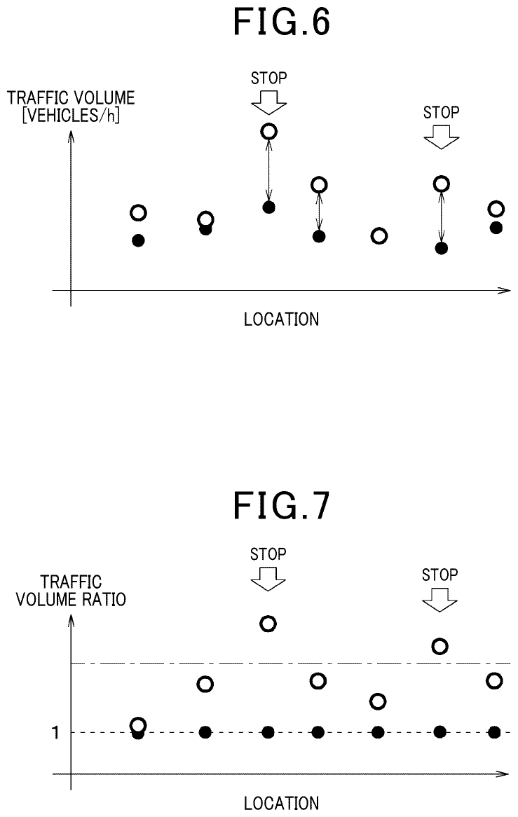

The present embodiment corresponds to a case in which the traffic condition index is the traffic volume. FIG. 6 illustrates changes in traffic volume between holidays and weekdays. In FIG. 6, the vertical axis represents the traffic volume, which indicates the number of vehicles passing per hour. In the plot of FIG. 6, a white circle (i.e., ◯) indicates a weekday, and a black circle (i.e., ●) indicates a holiday. It should be noted that the “traffic volume” in this case may be an average value for the whole day, or may be a value for a specific time slot.

As illustrated in FIG. 6, there are locations where a significant difference in traffic volume occurs between weekdays and holidays. Therefore, in the present embodiment, a stop location (that is, a deceleration location or a substantial stop location) is determined based on this difference.

Specifically, as illustrated in FIG. 6, a stop determination (that is, a deceleration determination) can be made when the difference in traffic volume between weekdays and holidays exceeds a threshold. In an alternative, as illustrated in FIG. 7, a stop determination (that is, a deceleration determination) may be made when a ratio of traffic volume between weekdays and holidays, plotted on the vertical axis, exceeds a threshold. The threshold is illustrated as the dashed-dotted line in FIG. 7. The present embodiment also achieves the similar effects as in the first embodiment described above.

### Modifications

The present disclosure is not limited to the above-described embodiment and example. Accordingly, modifications may be made as appropriate. Representative examples of such modifications are described below. In the following descriptions of the modification examples, only differences from the above embodiment will primarily be described. In addition, the same reference numerals are assigned to components that are identical or equivalent to those in the above embodiment. Therefore, in the following descriptions of the modification examples, the descriptions of the corresponding components in the above embodiment may be applied as appropriate, unless there is any technical inconsistency or need for special additional explanation.

The present disclosure is not limited to the specific applications or device configurations described in the above embodiments. That is, for example, the traveling state prediction device 1 may be used for various applications, in addition to predicting the vehicle driving energy and the remaining battery level.

All or part of the traveling state prediction device 1 may be provided on the external server side. Accordingly, for example, the deceleration location prediction unit 5 may be provided in the external server. In addition, the traffic condition index and the traffic variation factor may be acquired not individually but in a combined form. Specifically, for example, a predicted passing time through a congestion section caused by a traffic-affecting event conducted during a specific date and time range may be recognized as corresponding to a combination of a traffic condition index and a traffic variation factor. Therefore, the index acquisition unit 3 and the variation factor acquisition unit 4 may not necessarily be functionally distinguishable in some cases. However, even in such cases, it remains true that both the traffic condition index and the traffic variation factor are acquired.

All or part of the traveling state prediction device 1 may be implemented using a digital circuit, such as an ASIC or FPGA, configured to perform the functions or operations described above. “ASIC” stands for Application Specific Integrated Circuit, and “FPGA” stands for Field Programmable Gate Array. That is, in the traveling state prediction device 1, an on-board microcomputer and a digital circuit can coexist.

The program according to the present disclosure, which enables the various operations, procedures, or processes described in the above embodiment to be executed, may be downloaded or updated via V2X communication. “V2X” stands for Vehicle-to-Everything. Alternatively, such a program may be downloaded or updated via a terminal device installed at any of locations such as a manufacturing facility, maintenance facility, or dealership of the host vehicle V. The program may also be stored on a memory card, optical disc, magnetic disc, or the like.

Each of the above-described functional configurations and methods may be realized by a dedicated computer provided by configuring a processor and a memory programmed to execute one or more functions embodied by computer programs. Alternatively, each of the functional configurations and methods described above may be realized by a dedicated computer provided by configuring a processor with one or more dedicated hardware logic circuits. Alternatively, each of the functional configurations and methods described above may be realized by one or more dedicated computers configured by combining a processor and a memory programmed to execute one or more functions with a processor configured by one or more hardware logic circuits.

Further, the computer program may also be stored in a computer-readable, non-transitory, tangible storage medium as instructions to be executed by a computer. That is, each of the above-described functional configurations and methods may also be implemented as a computer program including procedures for executing the respective functions or methods described above, or as a non-transitory, tangible storage medium storing such a program.

The present disclosure is not limited to any of the specific operation modes described in the above embodiments. That is, for example, the time slot settings are not limited to every 20 minutes as illustrated in FIG. 2, and may instead be set at 1-minute intervals, 30-minute intervals, or 1-hour intervals. There is also no particular limitation on the intervals. That is, for example, by setting the interval to be as small as 10 meters or less, the vehicle speed pattern may become substantially continuous data.

In FIG. 4, the predicted vehicle speed Vt at the deceleration location is set to the standstill speed, i.e., 0 km/h, but the present disclosure is not limited to this configuration. That is, for example, there may be locations where the legal obligation to stop is not uniformly arises but arises according to the situation, such as at crosswalks without traffic lights. Taking such locations into consideration, the predicted vehicle speed Vt at the deceleration location may be set to a predefined value of 10 km/h or less, which is a slow speed, or more specifically, to a predefined value within a range of 1 to 3 km/h, corresponding to the slowest speed. In addition, the predicted vehicle speed Vt at each deceleration location may not be uniform, but may vary depending on individual traffic conditions.

Expressions such as “acquire,” “calculate,” “estimate,” “detect,” “sense,” and “determine” may be used interchangeably, provided that no technical inconsistency arises. Similarly, “detect,” “sense,” and “extract” may also be used interchangeably within a technically consistent scope. Furthermore, the expressions “exceeding a threshold” and “equal to or greater than a threshold” may be used interchangeably as long as they do not cause technical contradiction. The same applies to “less than a threshold” and “equal to or less than a threshold.”

It goes without saying that the elements constituting the above embodiments are not necessarily essential unless explicitly stated to be essential or unless they are clearly understood to be essential in principle. In addition, when a numerical value such as the number, value, amount, or range of a component in any of the above-described embodiments is mentioned, it should not be construed as being limited to that specific number or value unless expressly stated otherwise or unless it is clearly limited in principle. Furthermore, when the shape, direction, positional relationship, or the like of a component in any of the embodiments is described, it is not intended to be limited thereto unless explicitly stated otherwise or unless such limitation is clearly required in principle.

The modifications are not limited to the examples described above. For example, all or part of one of the specific examples may be combined with all or part of another, provided that no technical contradiction arises. There is no particular limitation on the number of examples that may be combined. Similarly, all or part of one of the modification examples may be combined with all or part of another, as long as there is no technical contradiction. Furthermore, any or all of the specific examples described above may be combined with any or all of the above modification examples, provided that no technical contradiction arises.

What is claimed is:

1. A traveling state prediction device for predicting a traveling state of a host vehicle, comprising:
an index acquisition unit configured to acquire a traffic condition index which is an index of a traffic condition on a planned travel route of the host vehicle;
a variation factor acquisition unit configured to acquire a traffic variation factor which is a factor that causes variations in the traffic condition; and
a deceleration location prediction unit configured to predict a deceleration location of the host vehicle on the planned travel route based on the traffic variation factor and the traffic condition index, wherein
the deceleration location prediction unit is configured to predict the deceleration location based on a relationship between the traffic condition indices in two different situations for a certain traffic variation factor, or a relationship between the traffic condition index corresponding to a certain traffic variation factor and the traffic condition index under an average traffic condition.

2. The traveling state prediction device according to claim 1, wherein
the index acquisition unit is configured to acquire, as the traffic condition index, information corresponding to a vehicle speed pattern of an individual vehicle or an average of vehicle speed patterns of a plurality of vehicles.

3. The traveling state prediction device according to claim 1, wherein
the index acquisition unit is configured to acquire, as the traffic condition index, information corresponding to a vehicle speed for each section when the planned travel route is divided into a plurality of sections.

4. The traveling state prediction device according to claim 1, wherein
the index acquisition unit is configured to acquire, as the traffic condition index, information corresponding to traffic volume at a plurality of locations along the planned travel route.

5. The traveling state prediction device according to claim 1, wherein
the variation factor acquisition unit is configured to acquire at least one of information relating to time and/or date, information relating to traffic volume, and information relating to weather.

6. The traveling state prediction device according to claim 1, wherein
the deceleration location prediction unit is configured to predict the deceleration location based on a difference between two traffic condition indices associated with a certain traffic variation factor, or a difference between the traffic condition index associated with a certain traffic variation factor and the traffic condition index under the average traffic condition.

7. The traveling state prediction device according to claim 1, wherein
the deceleration location prediction unit is configured to predict the deceleration location based on a ratio between two traffic condition indices associated with a certain traffic variation factor, or a ratio between the traffic condition index associated with a certain traffic variation factor and the traffic condition index under the average traffic condition.

8. A traveling state prediction method for predicting a traveling state of a host vehicle, comprising:
acquiring a traffic condition index which is an index of a traffic condition on a planned travel route of the host vehicle;
acquiring a traffic variation factor which is a factor that causes variations in the traffic condition; and
predicting a deceleration location of the host vehicle on the planned travel route based on the traffic variation factor and the traffic condition index, wherein
the predicting a deceleration location of the host vehicle comprises predicting the deceleration location based on a relationship between the traffic condition indices in two different situations for a certain traffic variation factor, or a relationship between the traffic condition index corresponding to a certain traffic variation factor and the traffic condition index under an average traffic condition.

9. A program product comprising:
a non-transitory computer-readable medium;
instructions stored on the non-transitory computer-readable medium that, when executed by a processor, cause the processor to perform a process for predicting a traveling state of a host vehicle, the process comprising operations of:
acquiring a traffic condition index which is an index of a traffic condition on a planned travel route of the host vehicle;
acquiring a traffic variation factor which is a factor that causes variations in the traffic condition; and
predicting a deceleration location of the host vehicle on the planned travel route based on the traffic variation factor and the traffic condition index, wherein
the operation of predicting a deceleration location of the host vehicle comprises predicting the deceleration location based on a relationship between the traffic condition indices in two different situations for a certain traffic variation factor, or a relationship between the traffic condition index corresponding to a certain traffic variation factor and the traffic condition index under an average traffic condition.

10. A non-transitory computer-readable medium storing instructions that, when executed by a processor, cause the processor to perform a process for predicting a traveling state of a host vehicle, the process comprising operations of:
acquiring a traffic condition index which is an index of a traffic condition on a planned travel route of the host vehicle;
acquiring a traffic variation factor which is a factor that causes variations in the traffic condition; and
predicting a deceleration location of the host vehicle on the planned travel route based on the traffic variation factor and the traffic condition index, wherein
the operation of predicting a deceleration location of the host vehicle comprises predicting the deceleration location based on a relationship between the traffic condition indices in two different situations for a certain traffic variation factor, or a relationship between the traffic condition index corresponding to a certain traffic variation factor and the traffic condition index under an average traffic condition.
